(19) United States
(12) Patent Application Publication
(10) Pub. No.: US 2007/0206116 A1
(43) Pub. Date: Sep. 6, 2007

(54) Camera module

(76) Inventor: Hsieh Cheng Chou, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/367,490

(22) Filed: Mar. 6, 2006

(51) Int. Cl. H01J 40/14; H04N 5/225

(52) U.S. Cl. 348/373

(57) ABSTRACT

A camera module comprises a bracket, a housing, an image capture unit received in the housing, a hinge and a lock element. The bracket is mounted on a mobile phone and defines a housing receiving space and a side space. The housing defines a hinge hole. The hinge has a sleeve and a pivot pin inserted in the sleeve. One end of the pivot pin and the sleeve are mounted in the mobile phone, and the other end of the pivot pin is mounted in the hinge hole, thereby pivotally connecting the housing to the mobile phone. The lock element is placed in the side space for locking the camera module in the housing receiving space. Once the lock element is unlocked, the camera module can be rotated out of the housing receiving space. The pivot pin defines at least one grease groove in its outer surface closing to the inner surface of the sleeve for accommodating grease functioned as a damper to control the rotation of the camera module so that the camera module can be rest in any angle.

### BACKGROUND OF THE INVENTION

1. Field of the Invention

The present invention relates generally to a camera module, and more particularly to a camera module adapted for being mounted on a mobile phone.

2. The Related Art

Nowadays, more and more mobile communication terminals are equipped with camera modules for capturing picture and video, such as U.S. Pat. No. 6,281,925, which discloses a type of cellular phone equipped with a camera module in the front of the cellular phone. In this solution, the cellular phone further comprises a LCD screen placed in the front of the cellular phone, that is, the camera module and the screen face to the same side. When users take self-portraits, they can preview photos on the LCD screen. However, on the other side, when users want to photo objects at the backside of the cellular phone, the cellular phone must be turned back to find view, so users can not preview photos on the LCD screen any more.

Another type of cellular phone, disclosed by U.S. Patent No. D500,992, has a camera module fixed in the back of the cellular phone. This type of cellular phone also comprises a LCD screen in the front of the cellular phone, that is, the camera module and the screen face to opposite sides. In this solution, users can preview photos when users photo objects at the backside of the cellular phone. However, users cannot preview photos in case of taking self-portraits.

Therefore, research developers really want to find a solution in which users can preview photos on the LCD screen whether the users take self-portraits or photo objects at the backside of the cellular phone.

### SUMMARY OF THE INVENTION

Therefore, an object of the present invention is to provide a camera module with an image capturing unit capable of rotating about an axis to adjust shooting angle while ensuring the LCD of the cellular phone faces to the users for facilitating previewing photos.

In order to achieve the above object, the present invention provides a camera module adapted for being mounted on a mobile phone comprising:

a housing defining a hinge hole;

an image capture unit received in the housing;

a flexible printed circuit board received in the housing, one end of the flexible printed circuit board electrically connecting to the image capture unit, and the other end of the flexible printed circuit board being adapted for electrically connecting to the mobile phone for transmitting image signals;

a bracket adapted for being mounted on the mobile phone, the bracket defining a housing receiving space for receiving the housing and a side space;

a hinge having a sleeve and a pivot pin inserted in the sleeve, the pivot pin providing a first pivot portion at one end thereof and a second pivot portion at the other end thereof, the pivot pin defining at least one grease groove in its outer surface closing to an inner surface of the sleeve for accommodating grease, the first pivot portion and the sleeve being mounted in the mobile phone, the second pivot portion being mounted in the hinge hole of said housing, thereby pivotally connecting the housing to the mobile phone; and

a lock element secured in the side space of the bracket for locking the housing in the housing receiving space of the bracket.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a mobile phone with a camera module according to the present invention;

FIG. 2 is a perspective view of the mobile phone showing the camera module being mounted on the mobile phone and in its retractile position;

FIG. 3 is an exploded view of the camera module shown in FIG. 1;

FIG. 4 is a perspective view of the camera module seen from below;

FIG. 5 is a partially cutaway view of a hinge of the camera module;

FIG. 6 is a perspective view of the mobile phone with the camera module removed therefrom; and

FIGS. 7 is a perspective view showing the camera module in its extended position.

### DETAILED DESCRIPTION OF THE PREFERRED EMBODIMENT

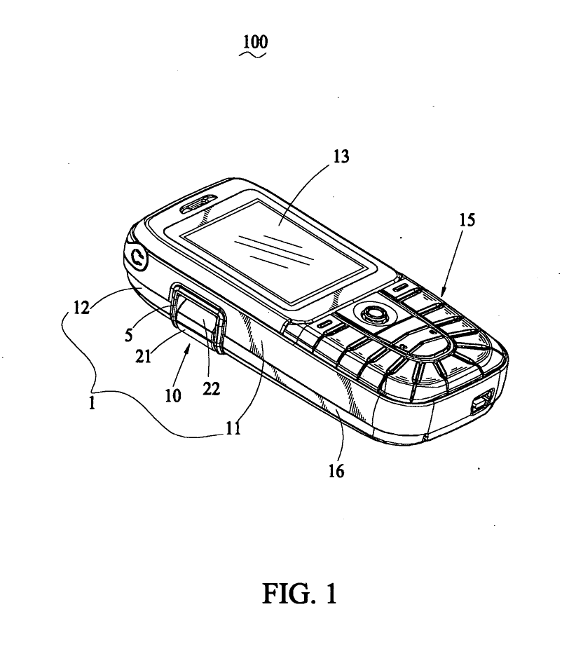

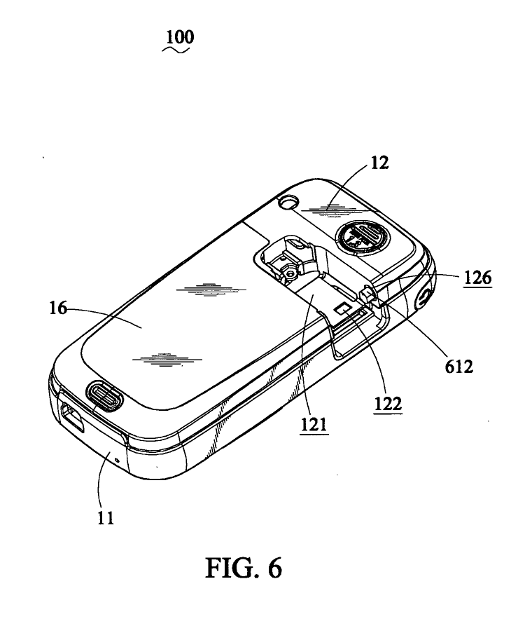

Please refer to FIGS. 1-3, a mobile phone 100 according to the present invention comprises a phone body 1 and a camera module 10. The phone body 1 consists of an upper shell 11 and a lower shell 12. The upper shell 11 disposes a LCD screen 13 on the upside thereof and a keypad 15 on the downside thereof. In conjunction with reference to FIG. 6, the lower shell 12 is equipped with a battery (not shown) on the downside thereof, and a battery cover 16 closes the battery in the phone body 1. The lower shell 12 is defined with a bracket receiving space 121 on the upside near the battery cover 16 for receiving the camera module 10. The lower shell 12 further defines a hinge-receiving hole 126 and a mounting hole 122 both communicating with the bracket receiving space 121.

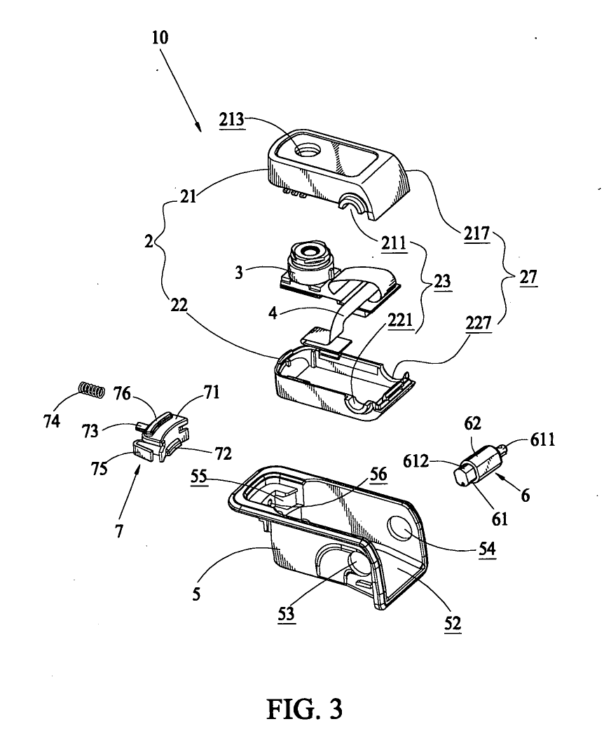

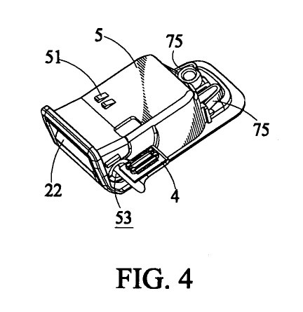

Please refer to FIG. 3 and FIG. 4, the camera module 10 comprises a housing 2, an image capture unit 3, a FPC (Flexible Printed Circuit) board 4, a bracket 5, a hinge 6, and a lock element 7.

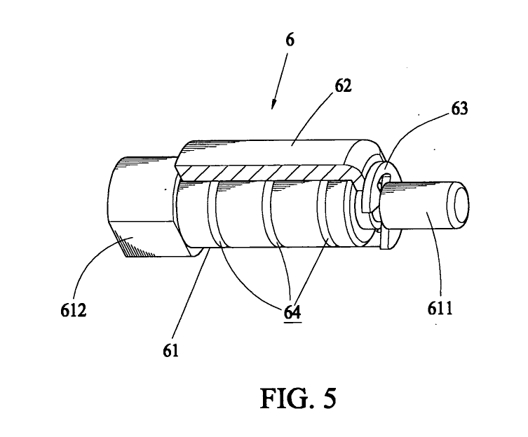

Please refer to FIGS. 3, 5 and 6, the hinge 6 comprises a sleeve 62, a pivot pin 61 inserted in the sleeve 62, and a C-shaped fixer for securing the sleeve 62 on the pivot pin 61. The pivot pin 61 is provided with a first pivot portion 611 at one end thereof and a second pivot portion 612 at the other side thereof. The pivot pin 61 further defines several grease grooves 64 in its outer surface closing to the inner surface of the sleeve 62. The grease grooves 64 are used to accommodate some damping grease to increase the friction between the sleeve 62 and the pivot pin 61. Therefore, the grease grooves 64 together with the grease are functioned as a damper. The first pivot portion 611 and the sleeve 62 are mounted in the hinge-receiving hole 126, and the second pivot portion 612 of the hinge 6 is projected into the bracket receiving space 121.

Referring back to FIG. 3 and FIG. 4 in conjunction with FIG. 6, the bracket 5 is defined with a housing receiving space 52 on one side therein for receiving the housing 2 and a side space 55 on the other side therein for receiving the lock element 7. The bracket 5 defines a second FPC hole 53 and a pivot hole 54 on two opposite side both communicating with the housing receiving space 52. The bracket 5 further forms a shaft-receiving hole 56 on the back wall thereof communicating with the side space 55 and a mounting block 51 (show in FIG. 4) on the bottom thereof. The bracket 5 is disposed in the bracket receiving space 121 with the mounting block 51 engaging with the mounting hole 122 so as to fix the bracket 5 into the phone body 1.

The lock element 7 comprises a locking body 71 and a spring 74. The locking body 71 has two U-shaped elastic pieces 75 formed on two opposite sides thereof, a handle 76 placed on the top thereof, a locking block 72 placed on one end thereof and a shaft 73 extending rearward. The spring 74 is retained on the shaft 73. The lock element 7 is placed in the side space 55 with the shaft 73 extending through the shaft-receiving hole 56 so as to guide the lock element 7 moving in the side space 55. Two opposite elastic pieces 75 elastically engage with the back wall of the bracket 5.

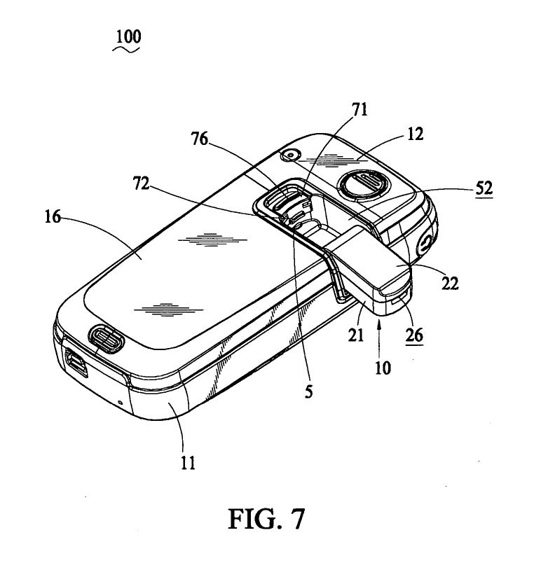

Please refer to FIG. 3, the image capture unit 3 utilized in this solution may be a CCD (Charged-Coupled Device) sensor or a CMOS (Complementary Metal-Oxide Semiconductor) sensor. The housing 2 comprises an upper housing 21 and a lower housing 22 that enclose the image capture unit 3 and the FPC board 4 therebetween. The upper housing 21 forms a first upper half-hole 211 and a second upper half-hole 217 on two opposite sides thereof. The lower housing 22 forms a first lower half-hole 221 and a second lower half-hole 227 on two opposite sides thereof corresponding to the first upper half-hole 211 and the second upper half-hole 217 respectively. The first upper half-hole 211 and the first lower half-hole 221 are aligned to define a first FPC hole 23. The second upper half-hole 217 and the second lower half-hole 227 are aligned to define a hinge hole 27. The upper housing 21 further defines a lens-receiving hole 213 on the top thereof corresponding to the image capture unit 3. With reference to FIG. 7, the housing 2 is defined with a matching groove 26 at one end thereof. The housing 2 together with the image capture unit 3 and the FPC board 4 is placed in the housing receiving space 52. The first pivot portion 611 of the hinge 6 is mounted into the hinge hole 27 through the pivot hole 54 so as to connect the housing 2 to the phone body 1 pivotally. One end of the FPC board 4 electrically connects to the image capture unit 3, and the other end of the FPC board 4 electrically connects to the mobile phone 100 through the first FPC hole 23 and the second FPC hole 53 for transmitting image signals. Therefore, the housing 2 together with the image capture unit 3 can rotate freely relative to the mobile phone 100.

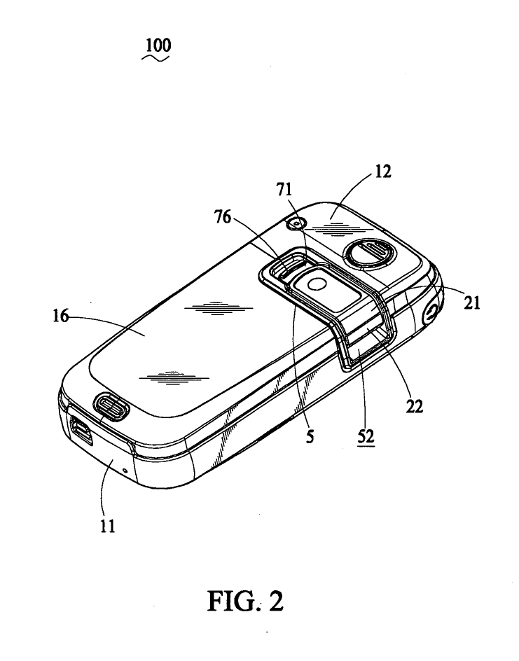

Please refer to FIG. 1 and FIG. 2, the housing 2 of the camera module 10 is placed in a retractile position in which the housing 2 is kept in the housing receiving space 52 of the bracket 5 and the image capture unit 3 faces to a side. The locking block 72 of the lock element 7 latches with the matching groove 26 of the housing 2 so as to keep the camera module 10 in the housing receiving space 52 steadily. In this state, the camera module 10 can find views at the backside of the mobile phone 100, and users can preview such images on the LCD screen 13.

Please refer to FIG. 7, which shows another state of the mobile phone. When users want to take self-portraits, they should move the handle 76 rearward to unlock the locking block 72 from the matching groove 26. Then the housing 2 together with image capture unit 3 is forced to rotate by hand to an extended position in which the housing 2 extends out of the housing receiving space 52 and the image capture unit 3 faces to the user to find view. In this state, the users can also preview self-portraits on the LCD screen 13. Furthermore, during the rotation of the housing 2 between the retractile position and the extended position, the grease grooves 64 together with the grease that functioned as a damper can control the rotation so that the camera module can be rest in any angle to adjust shooting angle, while the LCD screen 13 of the mobile phone is kept to face the users for facilitating previewing photos.

After taking self-portraits, users can push the housing 2 to rotate back to the housing receiving space 52. The locking block 72 is driven to latch with the matching groove 26 by the elastic force of the elastic piece 75 and the spring 74. The housing 2 thus is contained in the mobile phone 100 steadily so as to facilitate carrying and holding.

This invention has been described with reference to a specific embodiment. This description is not to be construed in a limiting sense. For example, those skilled in the art will recognize modifications and alterations that may be made to the embodiment illustrated herein. However, it is contemplated that such modifications can be made without departing the scope and spirit of the invention as defined in the following claims.

What is claimed is:

1. A camera module adapted for being mounted on a mobile phone comprising:
a housing defining a hinge hole;
an image capture unit received in said housing;
a flexible printed circuit board received in said housing, one end of the flexible printed circuit board electrically connecting to the image capture unit, and the other end of the flexible printed circuit board being adapted for electrically connecting to the mobile phone for transmitting image signals;
a bracket adapted for being mounted on the mobile phone, the bracket defining a housing receiving space for receiving said housing and a side space;
a hinge having a sleeve and a pivot pin inserted in the sleeve, the pivot pin providing a first pivot portion at one end thereof and a second pivot portion at the other end thereof, the pivot pin defining at least one grease groove in its outer surface closing to the inner surface of the sleeve for accommodating grease, the first pivot portion and the sleeve being mounted in the mobile phone, the second pivot portion being mounted in the hinge hole of said housing, thereby pivotally connecting the housing to the mobile phone; and
a lock element secured in the side space of said bracket for locking the housing in the housing receiving space of the bracket.

2. The camera module as claimed in claim 1, wherein the lock element has a lock block, and the housing defines a matching groove for engaging with the lock block.

3. The camera module as claimed in claim 1, wherein the lock element has a handle on the top thereof.

4. The camera module as claimed in claim 1, wherein the lock element has two U-shaped elastic pieces formed on two opposite sides thereof to engage with the back wall of the bracket.

5. The camera module as claimed in claim 1, wherein the lock element comprises a spring and has a shaft extending rearward and passing through the spring, the bracket defines a shaft-receiving hole in the back wall thereof communicating with the side space, free end of the shaft extends through the shaft-receiving hole.

6. The camera module as claimed in claim 1, wherein the bracket further has a mounting block on the bottom thereof for fixing the bracket to the mobile phone.

7. The camera module as claimed in claim 1, wherein the hinge is equipped with a C-shaped fixer to secure the sleeve 62 on the pivot pin 61.
